(19) United States
(12) Patent Application Publication
(10) Pub. No.: US 2009/0257209 A1
(43) Pub. Date: Oct. 15, 2009

(54) Semiconductor package and associated methods

(76) Inventors: Seong-Chan Han, Cheonan-si (KR); Jin-Kyu Yang, Seoul (KR); Dong-Chun Lee, Cheonan-si (KR); Kwang-Ho Chun, Asan-si (KR)

Correspondence Address: LEE & MORSE, P.C., 3141 FAIRVIEW PARK DRIVE, SUITE 500, FALLS CHURCH, VA, 22042, US

(21) Appl. No.: 12/385,575

(22) Filed: Apr. 13, 2009

(30) Foreign Application Priority Data
Apr. 14, 2008 (KR) 2008-0034318

(51) Int. Cl. H01R 9/00; H01R 12/04

(52) U.S. Cl. 361/772; 174/262

(57) ABSTRACT

A semiconductor package and associated methods, the semiconductor package including a substrate including a socket, and connection terminals including a solder ball and a supporting portion extending from the solder ball into the socket.

### BACKGROUND

1. Technical Field

Embodiments relate to a semiconductor package and associated methods.

2. Description of the Related Art

A ball grid array (BGA) package may be a high density surface mounting package using a printed circuit board (PCB) instead of a lead frame. The ball grid array (BGA) package may include, e.g., a ceramic ball grid array (CBGA) package, a plastic ball grid array (PBGA) package, a tape ball grid array (TBGA) package, a metal ball grid array (MBGA) package, and a fine pitch ball grid array (FBGA) package.

A general ball grid array (BGA) package may include solder balls that are disposed in a lattice shape between a semiconductor chip and a substrate (e.g., a printed circuit board) and may electrically connect the semiconductor chip to the substrate. After the semiconductor chip is mounted on a different substrate, e.g., a package substrate, the semiconductor chip may be electrically connected to the printed circuit board. Electrically connecting the substrates may include a step of welding solder balls to a connection pad by an annealing process after the solder balls are aligned with a ball land region of the substrate where the connection pad is formed. The welded solder balls may mechanically combine the semiconductor chip with the substrate as well as electrically connect the semiconductor chip to the substrate.

### SUMMARY

Embodiments are therefore directed to a semiconductor package and associated methods which substantially overcome one or more of the problems due to the limitations and disadvantages of the related art.

It is therefore a feature of an embodiment to provide a semiconductor package that is resistant against external shock.

At least one of the above and other features and advantages may be realized by providing a semiconductor package, including a substrate including a socket, and connection terminals including a solder ball and a supporting portion extending from the solder ball into the socket.

The socket may include a groove defined by a sidewall and a bottom surface or a hole penetrating the substrate.

The substrate may include a multi-layered substrate including a stacked insulating layer and an internal interconnection or a printed circuit board including an internal interconnection.

At least one connection terminal may be electrically isolated from the internal interconnection, and at least one other connection terminal may be electrically connected to the internal interconnection.

The semiconductor package may include a substrate including a first socket on a first side of the substrate and a second socket on a second side facing the first side, a first connection terminal including a first solder ball and a first supporting portion extending from the first solder ball into the first socket, and a second connection terminal including a second solder ball and a second supporting portion extending from the second solder ball into the second socket.

The first and second sockets may include a groove defined by a sidewall and a bottom surface respectively.

The first and second sockets may be defined by a hole penetrating the substrate, and the first supporting portion is connected to the second supporting portion in the hole.

The semiconductor package may further include an insulating member interposing between the first supporting portion and the second supporting portion in the hole and the insulating member isolating the first connection terminal and the second connection terminal electrically.

At least one of the above and other features and advantages may also be realized by providing a semiconductor package, including a printed circuit board including internal interconnections and sockets, at least one package substrate facing the printed circuit board, and connection terminals between the printed circuit board and the package substrate, each of the connection terminals including a supporting portion, the supporting portion being disposed within one of the sockets.

At least some of the sockets may include a groove defined by a sidewall and a bottom surface or a hole penetrating the substrate.

The connection terminals may include support terminals and signal terminals, the support terminals may be electrically isolated from the internal interconnections, and the signal terminals may be electrically connected to the internal interconnections, the printed circuit board, and the package substrate.

The support terminals may be disposed at an edge region of the package substrate.

The support terminals may be disposed at a corner region of the edge region of the package substrate.

The sockets may include holes penetrating the substrate, the package substrate may include a first package substrate on which a first semiconductor chip is mounted, the first package substrate may be coupled to a first side of the printed circuit board, and a second package substrate on which a second semiconductor chip is mounted, the second package substrate may be coupled to a second side of the printed circuit board, and the connection terminals may include first connection terminals between the printed circuit board and the first package substrate, each of the first connection terminals corresponding to a socket, and second connection terminals between the printed circuit board and the second package substrate, each of the second connection terminals corresponding to a socket, wherein a first connection terminal corresponding to a socket may be electrically connected to a second connection terminal corresponding to the same socket.

The sockets may include holes penetrating the substrate and insulating members in the holes, the package substrate may include a first package substrate on which a first semiconductor chip is mounted, the first package substrate may be coupled to a first side of the printed circuit board, and a second package substrate on which a second semiconductor chip is mounted, the second package substrate may be coupled to a second side of the printed circuit board, and the connection terminals may include first connection terminals between the printed circuit board and the first package substrate, each of the first connection terminals corresponding to a socket, and second connection terminals between the printed circuit board and the second package substrate, each of the second connection terminals corresponding to a socket, wherein a first connection terminal corresponding to a socket may be electrically isolated by the insulating member from a second connection terminal corresponding to the same socket.

At least one of the above and other features and advantages may also be realized by providing a method of manufacturing a semiconductor package, the method including forming sockets on a first substrate, aligning a connection terminal including a solder ball on one of the sockets, and forming a supporting portion by heating the solder ball to insert a portion of the solder ball into the socket.

The step of forming the sockets on the first substrate may include forming a groove defined by a sidewall and a bottom surface on the first substrate or forming a hole penetrating the first substrate.

The method may further include providing at least one package substrate on which a semiconductor chip is mounted and including connection terminals, aligning a plurality of the connection terminals with the sockets, and inserting a portion of each connection terminal into the socket to couple the package substrate to the first substrate, wherein the first substrate includes a printed circuit board including an internal interconnection.

The connection terminals may include support terminals and signal terminals, the support terminals may be electrically isolated from the internal interconnection, and the signal terminals may be electrically connected to the internal interconnections, the printed circuit board, and the package substrate.

The at least one package substrate may include a first package substrate and a second package substrate, and the method may further include coupling the first package substrate, including at least one first connection terminal and on which a first semiconductor chip is mounted, to a first side of the first substrate, and coupling a second package substrate, including at least one second connection terminal and on which a second semiconductor chip is mounted, to a second side of the first substrate, wherein the sockets include at least one socket with a hole penetrating the first substrate, and one of the first connection terminals corresponding to the socket with a hole penetrating the first substrate is electrically connected to one of the second connection terminals corresponding to the same socket with a hole penetrating the first substrate, electrically connecting the first semiconductor chip and the second semiconductor chip.

The at least one package substrate may include a first package substrate and a second package substrate and the sockets may include at least one socket with a hole penetrating the first substrate, and the method may further include coupling the first package substrate, including at least one first connection terminal and on which a first semiconductor chip is mounted, to a first side of the first substrate, and coupling the second package substrate, including at least one second connection terminal and on which a second semiconductor chip is mounted, to a second side of the first substrate, forming an insulating member in one of the sockets with a hole penetrating the first substrate, wherein one of the first connection terminals corresponding to the socket with a hole penetrating the first substrate is electrically isolated by the insulating member from one of the second connection terminals corresponding to the same socket with a hole penetrating the first substrate.

### BRIEF DESCRIPTION OF THE DRAWINGS

The above and other features and advantages of the embodiments will become more apparent to those of ordinary skill in the art by describing in detail exemplary embodiments thereof with reference to the attached drawings, in which:

FIG. 1 illustrates a top plan view of a semiconductor package according to an embodiment;

FIG. 2 illustrates a cross sectional view taken along the line I-I′ illustrated in FIG. 1;

FIG. 3 illustrates a view of a semiconductor package according to an embodiment;

FIGS. 4 through 6 illustrate views of a semiconductor package according to an embodiment;

FIG. 7 illustrates a view of a configuration of connection terminals according to an embodiment;

FIG. 8 illustrates a view of a configuration of connection terminals according to an embodiment;

FIG. 9 illustrates a flow chart of a method of manufacturing a semiconductor package illustrated in FIG. 2;

FIGS. 10A through 10C illustrate views of a process of manufacturing a semiconductor package illustrated in FIG. 2;

FIG. 11 illustrates a flow chart of a method of manufacturing a semiconductor package illustrated in FIG. 3;

FIGS. 12A through 12D illustrate views of a process of manufacturing a semiconductor package illustrated in FIG. 3;

FIG. 13 illustrates a flow chart of a method of manufacturing a semiconductor package illustrated in FIG. 4;

FIGS. 14A through 14D illustrate views of a process of manufacturing a semiconductor package illustrated in FIG. 4;

FIG. 15 illustrates a flow chart of a method of manufacturing a semiconductor package illustrated in FIG. 5;

FIGS. 16A through 16D illustrate views of a process of manufacturing a semiconductor package illustrated in FIG. 5;

FIG. 17 illustrates a flow chart of a method of manufacturing a semiconductor package illustrated in FIG. 6;

FIGS. 18A through 18E illustrate views of a process of manufacturing a semiconductor package illustrated in FIG. 6;

FIG. 19 illustrates a view of a package module including a semiconductor package to which a technique of an embodiment is applied;

FIG. 20 illustrates a block diagram of an electronic device including a semiconductor device to which a technique of an embodiment is applied; and

FIG. 21 illustrates a block diagram of a memory system including a semiconductor device to which a technique of an embodiment is applied.

### DETAILED DESCRIPTION

Korean Patent Application No. 2008-0034318, filed on Apr. 14, 2008, in the Korean Intellectual Property Office, and entitled: “Semiconductor Package and Methods of Manufacturing the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “a resin” may represent a single compound, e.g., phenol resin or multiple compounds in combination, e.g., phenol resin mixed with epoxy resin.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Embodiments may be described with reference to cross-sectional illustrations, which are schematic illustrations of idealized embodiments. As such, variations from the shapes of the illustrations, as a result, for example, of manufacturing techniques and/or tolerances, are to be expected. Thus, embodiments should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Spatially relatively terms, such as “beneath,” “below,” “above,” “upper,” “top,” “bottom” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented (rotated 90 degrees or at other orientations) and the spatially relative descriptors used herein interpreted accordingly. As used herein, “height” refers to a direction that is generally orthogonal to the faces of a substrate.

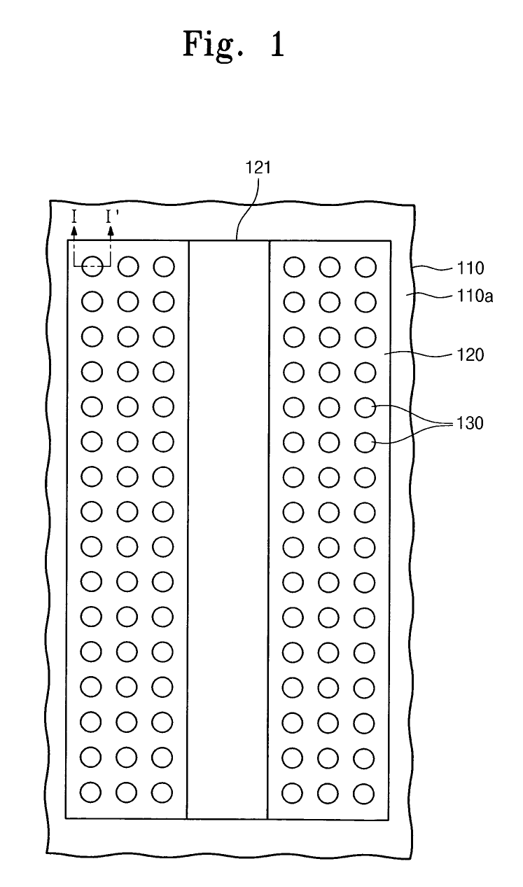

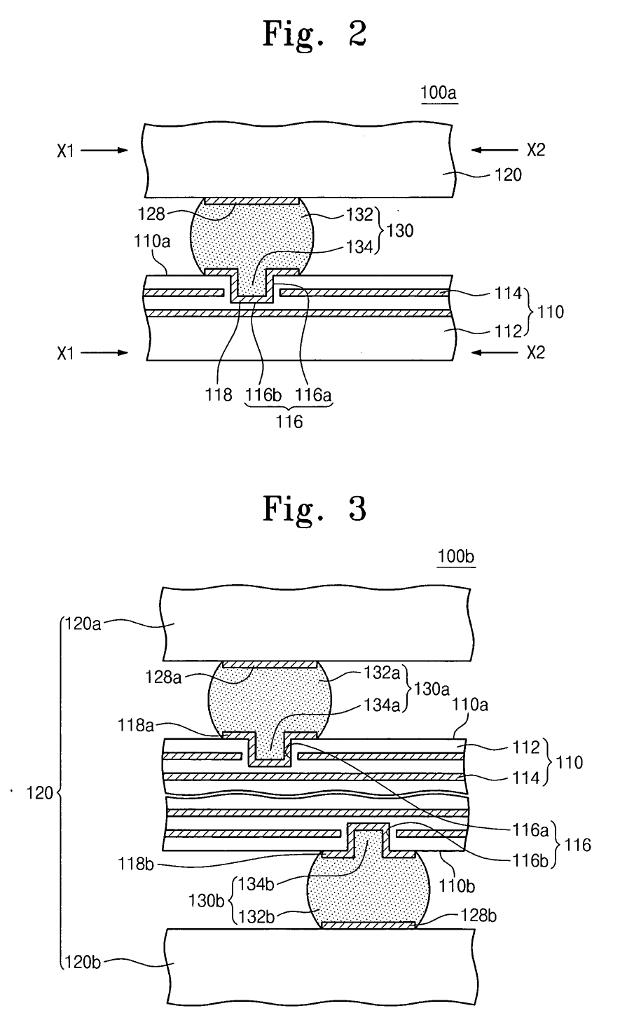

Referring to FIGS. 1 and 2, a semiconductor package 100a according to an embodiment may include at least one substrate and a plurality of connection terminals provided to the substrate. The semiconductor package 100a may include a first substrate 110, a second substrate 120 on the first substrate 110 and a plurality of connection terminals 130 disposed between the first substrate 110 and the second substrate 120. The first substrate 110 may be, e.g., a printed circuit board (PCB) or build-up board, on which an insulating layer and interconnections may be stacked.

The second substrate 120 may be disposed opposite to the first substrate 110 on one side of the first substrate 110. The second substrate 120 may be, e.g., a package substrate, on which a semiconductor chip (not shown) may be mounted. A chip mounting region 121 for mounting the semiconductor chip may be provided to the second substrate 120. The connection terminal 130 may include solder ball, a portion of which may be inserted into the first substrate 110.

The configuration and the number of the second substrates 120 coupled to the first substrate 110 may vary. The second substrate 120 may be disposed on sides of the first substrate 110. A second substrate 120 disposed on a first side 110a of the first substrate 110 may be symmetrical to another second substrate (not shown) disposed on a second side of the first substrate 110, with respect to the first substrate 110. The second side of the first substrate 110 may be opposite to the first side 110a of the first substrate 110.

A structure of the connection terminal 130 will be described. A connection terminal which will be described below may include one of the connection terminals depicted in FIG. 1.

A plurality of sockets, for insertion of a portion of the connection terminal 130, may be formed on the first substrate 110. Each of the sockets may be, e.g., a groove 116 having a sidewall 116a and a bottom surface 116b. The groove 116 may be a indentation having a rounded cross-sectional shape. A first connection pad 118 may be formed on the groove 116. A second connection pad 128 may be formed on the second substrate 120 where the second substrate 120 contacts the connection terminals 130.

Each of the connection terminals 130 may include a solder ball 132 and a supporting portion 134. The supporting portion 134 may extend from the solder ball 132 into the groove 116. The supporting portion 134 may advantageously prevent the solder ball 132 from being damaged by an external physical shock by supporting the solder ball 132 in the groove 116. When an external physical shock, e.g., bending, is applied to the first and second substrates 110 and 120, the external physical shock may be transferred to the solder ball 132. In particular, if an external physical shock is applied to the first and second substrates 110 and 120 in a horizontal direction (X1 and X2 in FIG. 2), e.g., the external shock acts on the solder ball 132 as a shear, the supporting portion 134 may function as a supporting axis of the solder ball 132. Thus, damage to the connection terminals 130 due to an external physical shock may be beneficially reduced when compared with conventional connection terminals. Also, since the supporting portion 134 may be formed to extend from the solder ball 132, the solder ball 132 and the supporting portion 134 may be formed from the same material. Therefore, since an interface may not be formed between the solder ball 132 and the supporting portion 134, the connection portion between the solder ball 132 and the supporting portion 134 may be sufficiently strong against the external physical shock.

Referring to FIGS. 1 and 3, a semiconductor package 100b according to another embodiment may include the first substrate 110, and package substrates disposed on two sides of the first substrate 110. The semiconductor package 100b may include the first substrate 110 on which sockets are formed, a first package substrate 120a disposed on a first side 110a of the first substrate 110, and a second package substrate 120b disposed on a second side 110b of the first substrate 110. The connection terminals 130 may include first connection terminals 130a and second connection terminals 130b. The first connection terminals 130a may be between the first substrate 110 and the first package substrate 120a, and the second connection terminals 130b may be between the first substrate 110 and the second package substrate 120b.

The sockets may include a first socket portion formed on a first side 110a of the first substrate 110, and a second socket portion formed on a second side 110b of the first substrate 110. The sockets may include a first groove 116a and a second groove 116b, which have the same structure as the groove 116 shown in FIG. 2. The first groove 116a may be formed on the first side 110a of the first substrate 110, and the second groove 116b may be formed on the second side 110b of the first substrate 110. The first and second grooves 116a and 116b may be symmetrically disposed with respect to the first substrate 110. That is, the first groove 116a and the second groove 116b may be disposed on a same line which is perpendicular to the first substrate 110.

The semiconductor package 110b may include a first pad 118a (FIG. 3) on the first groove 116a and a second pad 118b on the second groove 116b. Additionally, a third pad 128a, which may be in contact with the first connection terminals 130a, may be on the first package substrate 120a. A fourth pad 128b, which may be in contact with the second connection terminals 130b, may be on the second package substrate 120b.

The first connection terminals 130a may include a solder ball 132a and a supporting portion 134a, which may extend from the solder ball 132a into the first groove 116a. The supporting portion 134a may support the solder ball 132a in the first groove 116a. The second connection terminals 130b may include a solder ball 132b and a supporting portion 134b, which may extend from the solder ball 132b into the second groove 116b. The supporting portion 134b may support the solder ball 132b in the second groove 116b.

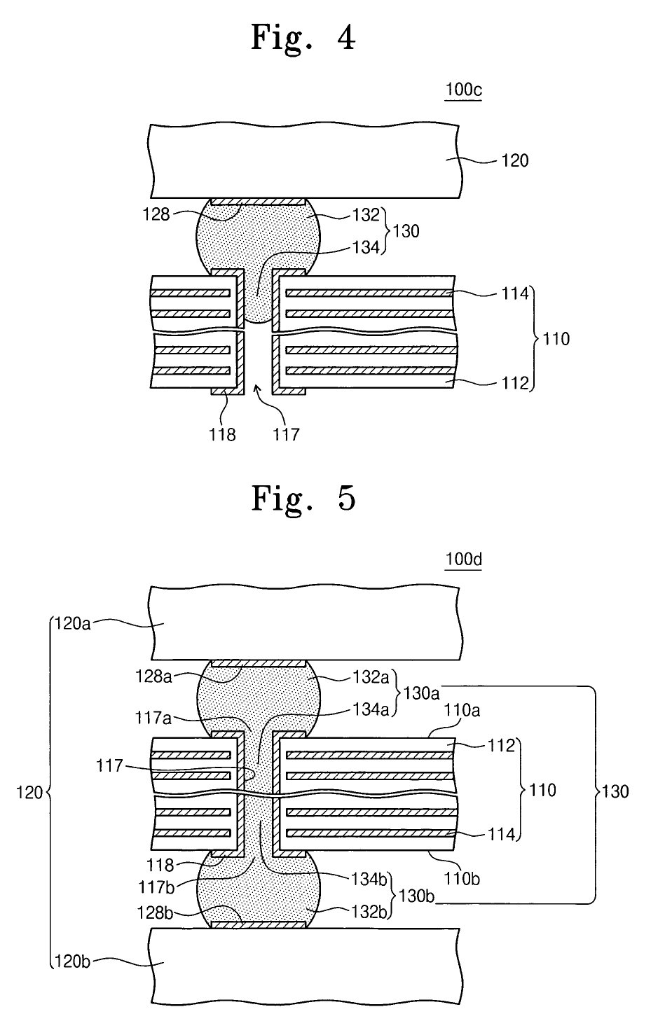

Referring to FIGS. 1 and 4, in a semiconductor package 100c according to another embodiment, sockets in which a portion of the connection terminal 130 is inserted may be penetration holes 117, penetrating the first substrate 110. The semiconductor package 100c may include the first substrate 110 in which the penetration holes 117 are formed, a second substrate 120 on one side 110a of the first substrate 110, and the connection terminals 130 between the first substrate 110 and the second substrate 120. A connection pad 118 may be in the penetration holes 117, and the connection terminals 130 may be welded onto the penetration holes 117 and connection pad 118. A second connection pad 128 may be on the second substrate 120, and in contact with the connection terminals 130. Each of the connection terminals 130 may include a solder ball 132 and a supporting portion 134, which may extend from the solder ball 132 into the penetration hole 117.

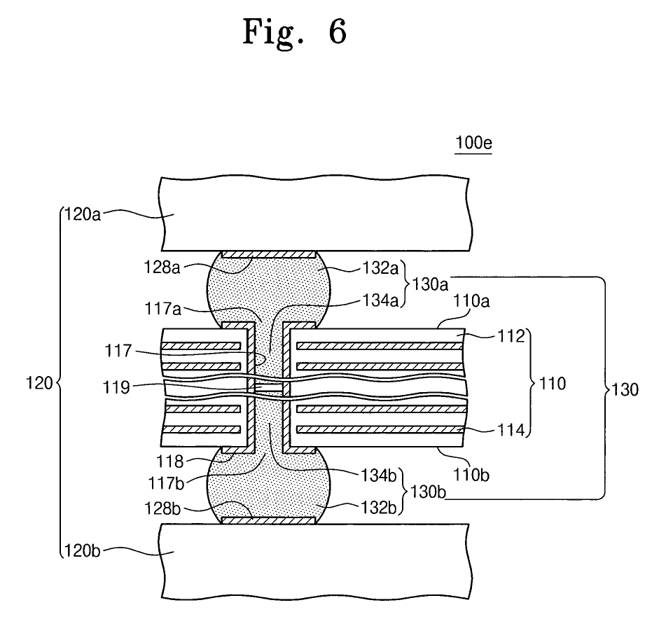

Referring to FIGS. 1 and 5, in a semiconductor package 100d, sockets may include penetration holes 117 penetrating the first substrate 110, and two connection terminals 130 may be disposed on one penetration hole 117. The semiconductor package 100d may include the first substrate 110 including the penetration holes 117, and first and second package substrates 120a and 120b disposed on a first and second side of the first substrate 110, respectively. A first pad 118 may be in the penetration holes 117. A third pad 128a may be on the first package substrate 120a, and in contact with the connection terminals 130. A fourth pad 128b may be on the second package substrate 120b, and in contact with the connection terminals 130.

The connection terminals 130 may include a first connection terminal 130a, which may be welded on a first opening 117a of the penetration hole 117, and a second connection terminal 130b, which may be welded on a second opening 117b of the penetration hole 117. The first connection terminal 130a may include a solder ball 132a and a supporting portion 134a extending from the solder ball 132a into the penetration hole 117. The second connection terminal 130b may include a solder ball 132b and a supporting portion 134b extending from the solder ball 132b into the penetration hole 117. A supporting portion 134a of the first connection terminal 130a, and a supporting portion 134b of the second connection terminal 130b may be disposed in the penetration hole 117. Furthermore, the supporting portion 134a of the first connection terminal 130a and the supporting portion 134b of the second connection terminal 130b may be connected to each other in the penetration hole 117.

Referring to FIGS. 1 and 6, a semiconductor package 100e may include the semiconductor package 100d described by referring to FIG. 5 further including an insulating member 119. The insulating member 119 may electrically isolate the supporting portions 134a and 134b of the first and second connection terminals 130a and 130b in the penetration hole 117. The first connection terminal 130a may electrically connect the first substrate 110 to the first package substrate 120a and the second connection terminal 130b may electrically connect the first substrate 110 to the second package substrate 120b.

The connection terminals 130 may electrically connect the first substrate 110 to the second substrate 120, or the connection terminals 130 may support a physical connection of the first substrate 110 and the second substrate 120. The connection terminals 130 may include, e.g., signal terminals electrically connecting the first substrate 110 to the second substrate 120 and supporting terminals reinforcing a physical connection between the first substrate 110 and the second substrate 120. The signal terminals and the supporting terminals may be differentiated by whether they are connected to interconnections on the first substrate 110. The first substrate 110 may be, e.g., a printed circuit board including stacked insulating layer 112 and internal interconnections 114, and external interconnections (not shown) may be formed on a surface of the first substrate 110. The connection pad 118 may be connected to the internal interconnections 114. The connection terminals 130 welded on the connection pad 118 may be used as the signal terminals. That is, the signal terminal may electrically connect a printed circuit board of the first substrate 110 and a semiconductor chip of the second substrate 120. The connection pad 118 may be separated from the internal interconnection 114 and the external interconnection. In this case, the connection terminals 130 welded on the connection pad 118 may be used as supporting terminals. That is, the supporting terminals may not be terminals electrically connecting the first substrate 110 and the second substrate 120, but may reinforce a physical connection between the first substrate 110 and the second substrate 120.

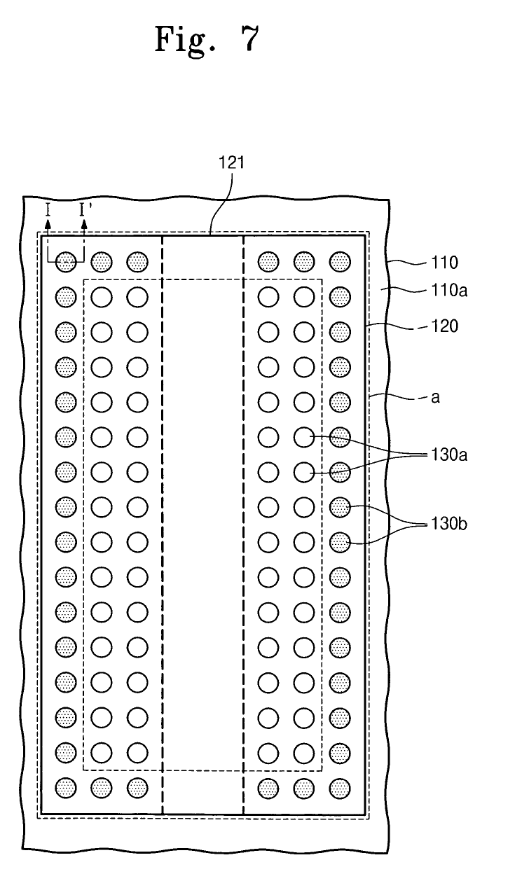

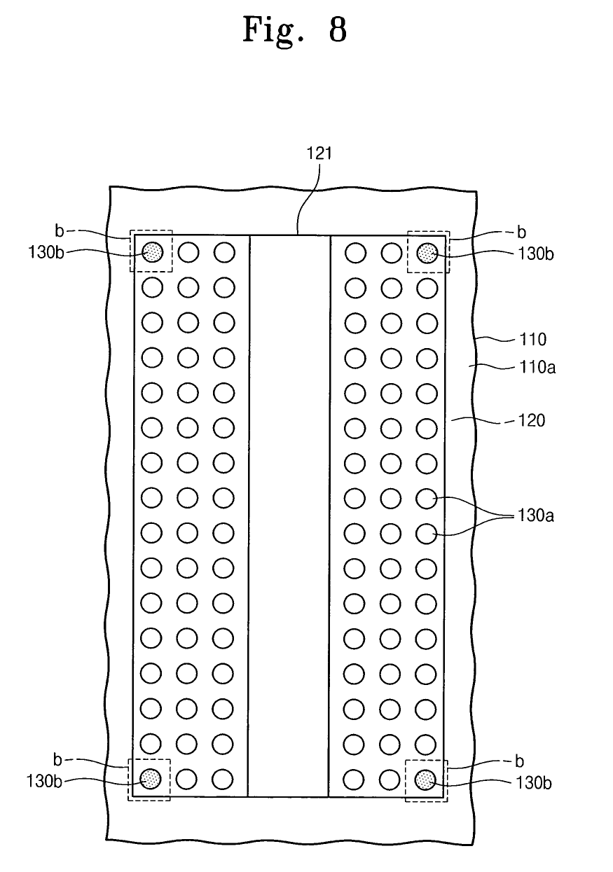

Referring to FIG. 7, the supporting terminals may be disposed along an edge region (a) of the second substrate 120. The signal terminals may be disposed at an internal region of the second substrate 120. Referring to FIG. 8, the supporting terminals may be disposed at a corner region (b) of the second substrate 120. Additionally, the supporting terminals may also be disposed on a region of the second substrate 120 other than the edge region (a) and the corner region (b).

The connection terminals 130 illustrated in FIGS. 2 through 6 may be used as the supporting terminals. Even if an external shock is applied to the first and second substrates 110 and 120, the assembly will be highly resistant to the usual phenomenon wherein the signal terminals,—i.e., the terminals without any support portion disposed on a region other than the edge region (a) and the corner region (b)—are damaged by an external shock.

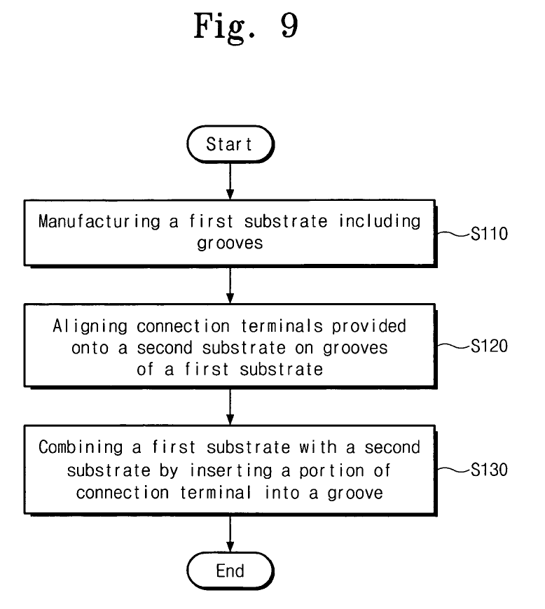

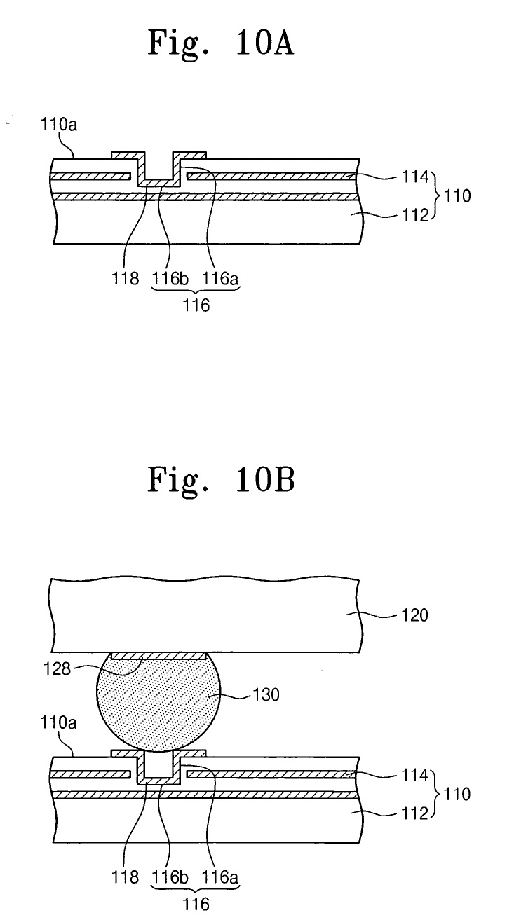

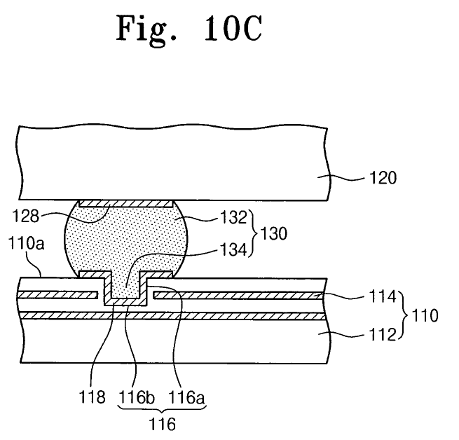

Hereinafter, a method of manufacturing a semiconductor package 100a according to an embodiment referring to FIG. 2 will be described. Referring to FIGS. 9 and 10A, a first substrate 110 including grooves 116 may be manufactured (S110). The first substrate 110 may be a multi-layered substrate in which an insulating layer 112 and an internal interconnection 114 may be repeatedly stacked, and an external interconnection (not shown) may be formed on a surface of the first substrate 110. The grooves 116 may be formed by, e.g., a laser drill. When the first substrate 110 is a multi-layered substrate, the grooves 116 may be formed while stacking layers for manufacturing the first substrate 110. For example, a layer in which holes used as the grooves 116 are formed may be adhered to a layer where holes are not formed to manufacture the first substrate 110. First connection pads 118 may be formed on the grooves 116. The first connection pads 118 may be formed using, e.g., an electroplating method or an electroless plating method. The first connection pads 118 may be formed of, e.g., metal material having a superior electrical conductivity. The first connection pads 118 may be formed of, e.g., copper (Cu).

Referring to FIGS. 9 and 10B, connection terminals 130 included in the second substrate 120 may be aligned with the grooves 116 of the first substrate 110 (S120). That is, second connection pads 128 may be provided on one side of the second substrate 120, and the connection terminals 130 may be welded on the second connection pads 128. The side of the second substrate 120 including the connection terminals 130 may face a side 110a of the first substrate 110 to align the connection terminals 130 with the grooves 116. Before aligning the connection terminals 130 with the grooves 116, a process of doping flux on the first connection pads 118 may be performed. The flux may be, e.g., a material for welding the connection terminals 130 to the first connection pads 118.

Referring to FIGS. 9 and 10C, the connection terminals 130 may be inserted into the grooves 116 by heating the connection terminals 130, to couple the second substrate 120 and the first substrate 110 (S130). A portion of the connection terminal 130 formed in the grooves 116 may be a supporting portion 134 supporting a solder ball 132. Since the supporting portion 134 may extend from the connection terminal 130, an undesirable, structurally weak interface between the solder ball 132 and the supporting portion 134 may be avoided. Also, since the solder ball 132 and the supporting portion 134 may be a same material, they may be formed to be one body. The solder ball 132 and the supporting portion 134 may include at least one of tin (Sn), lead (Pb), silver (Ag), and copper (Cu).

A method of manufacturing a semiconductor package 100b described referring to FIG. 3 will be described in detail. A specific description of structures of the semiconductor package 100b described referring to FIG. 3 may be omitted. Also, the description of common features already discussed in a process of manufacturing the semiconductor package 100a will be omitted for brevity.

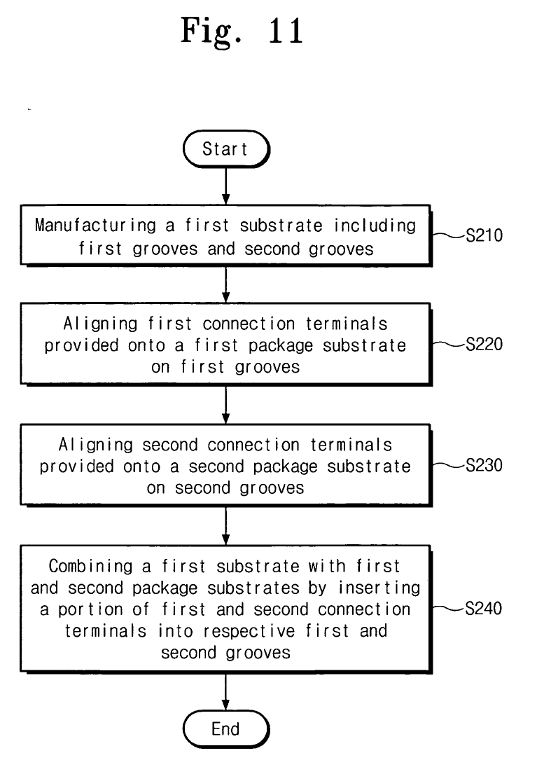

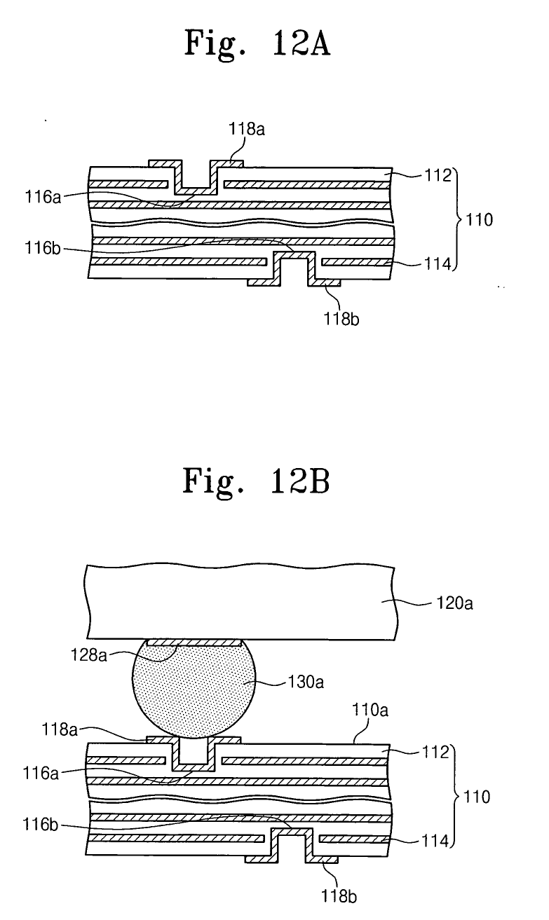

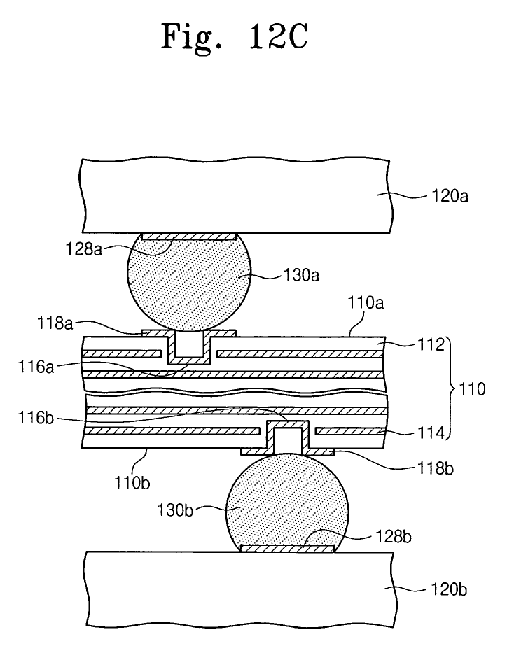

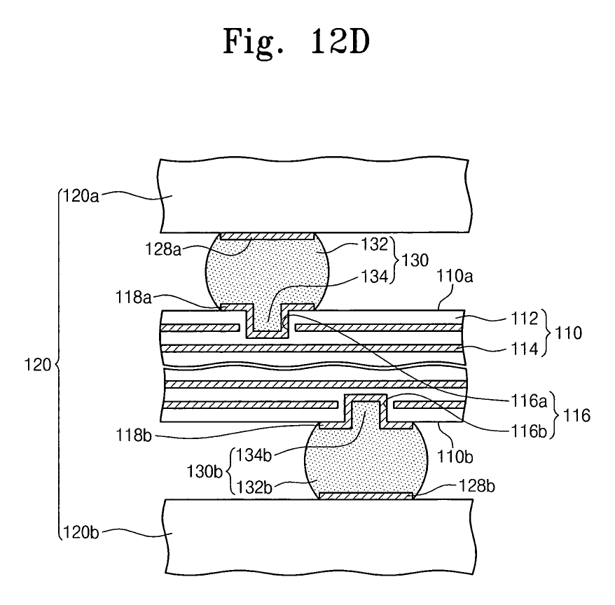

Referring to FIGS. 11 and 12A, a first substrate 110 may be manufactured with grooves formed on more than one side (S210). The first substrate 110 may be a multi-layered substrate wherein an insulating layer 112 and an internal interconnection 114 are repeatedly stacked, and an external interconnection (not shown) may be formed on the first substrate 110. First grooves 116a may be formed on a first side 110a of the first substrate 110, and second grooves 116b may be formed on a second side 110b of the first substrate 110. The first and second grooves 116a and 116b may be formed using the same method as the method of forming the grooves 116 described referring to FIGS. 9 and 10a. First pads 118a may be formed on the first grooves 116a, and second pads 118b may be formed on the second grooves 116b. The first and second pads 118a and 118b may be formed using the same method as the method of forming the first connection pads 118 described referring to FIGS. 9 and 10a.

Referring to FIGS. 11 and 12B, first connection terminals 130a on a first package substrate 120a may be aligned with the first grooves 116a of the first substrate 110 (S220). The first package substrate 120a may be a substrate on which a semiconductor chip is mounted. Third pads 128a for welding the first connection terminals 130a may be formed on the first package substrate 120a. A side of the first package substrate 120a including the first connection terminals 130a may face a side 110a of the first substrate 110, to align the first connection terminals 130a with the first grooves 116a.

Referring to FIGS. 11 and 12C, second connection terminals 130b provided on a second package substrate 120b may be aligned with the second grooves 116b of the first substrate 110 (S230). The second package substrate 120b may be a substrate on which a semiconductor chip mounted on the first package substrate 120a, and/or another chip may be mounted. Fourth pads 128b for welding the second connection terminals 130b may be formed on the second package substrate 120b. A side of the second package substrate 120b including the second connection terminals 130b may face a side 110b of the first substrate 110, to align the second connection terminals 130b with the second grooves 116b. Referring to FIGS. 11 and 12d, the first and second connection terminals 130a and 130b may be inserted into the first and second grooves 116a and 116b by heating the first and second connection terminals 130a and 130b to couple the first and second package substrate 120a and 120b to the first substrate 110 (S240).

A process of manufacturing the semiconductor package 100c described referring to FIG. 4 will be described in detail. A specific description of structures of the semiconductor package 100c already described with reference to FIG. 4 will be omitted.

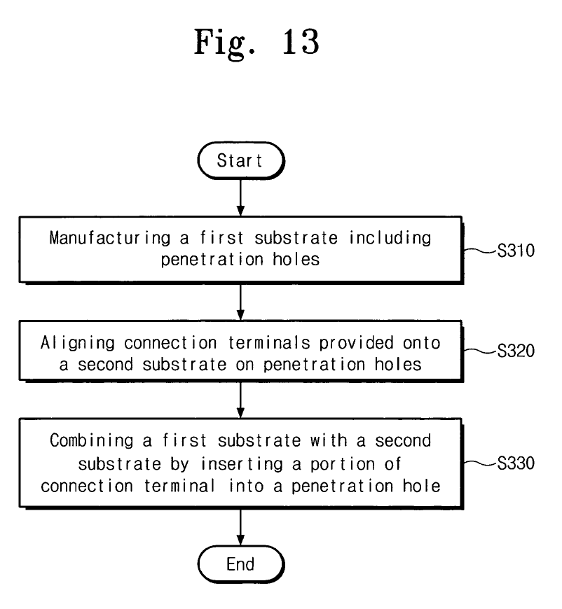

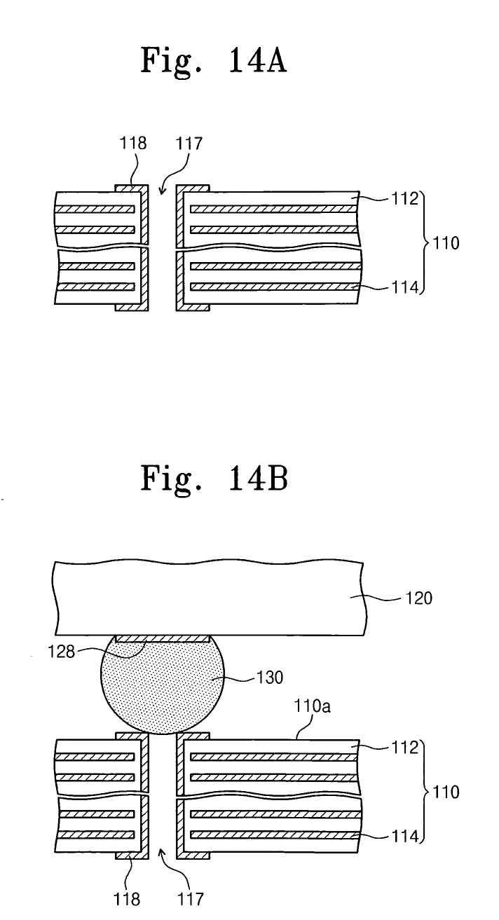

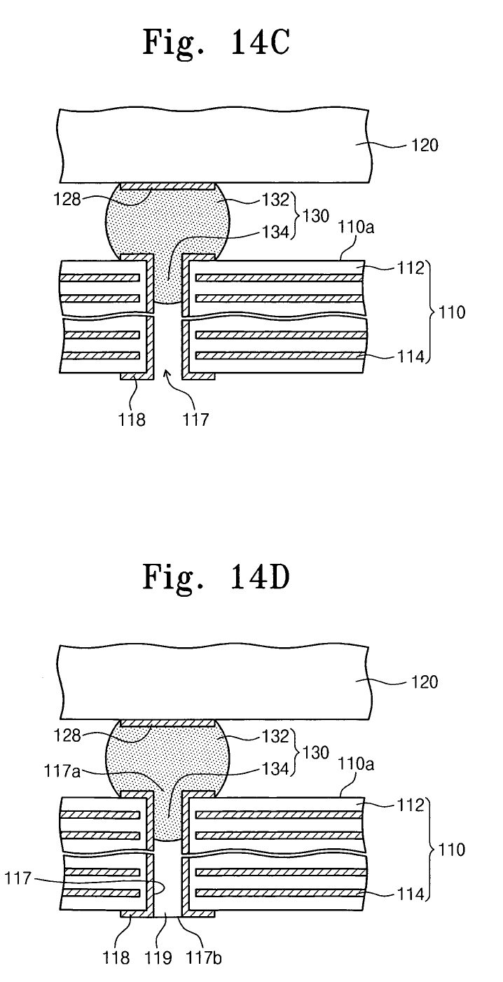

Referring to FIGS. 13 and 14A, a first substrate 110 may be manufactured and may include penetration holes 117 (S310). The first substrate 110 may be a multi-layered substrate wherein an insulating layer 112 and an internal interconnection 114 are stacked, and an external interconnection (not shown) may be formed. The penetration holes 117 may be formed by, e.g., a punching method using a laser drill. The first connection pads 118 may be formed on the penetration holes 117.

Referring to FIGS. 13 and 14B, connection terminals 130 on the second substrate 120 may be aligned with the penetration holes 117 (S320). The second substrate 120 may be a substrate on which a semiconductor chip (not shown) is mounted. A second connection pad 128 for welding the connection terminals 130 may be on the second substrate 120. A side of the second substrate 120 on which the connection terminals 130 may be formed may face a side 110a of the first substrate 110 to align the connection terminals 130 with the penetration holes 117.

Referring to FIGS. 13 and 14C, the connection terminals 130 may be inserted into the penetration holes 117 by heating the connection terminals 130, coupling the second substrate 120 to the first substrate 110 (S330).

Referring to FIG. 14D, a second opening 117b of the penetration hole 117 may include an insulating member 119. Before the connection terminal 130 is welded on the penetration hole 117, a step of forming the insulating member 119 in the penetration hole 117 may be performed. Alternatively, the insulating member 119 may be formed by a method of filling the second opening 117b of the penetration hole 117 after welding the connection terminals 130 on a first opening 117a of the penetration hole 117. The insulating member 119 may prevent the supporting portion 134, from extending to the second side 10b of the first substrate 110 through the second opening 117b of the penetration hole 117. The insulating member 119 may include the same material as the insulating layer 112 of the first substrate 110. The insulating member 119 may include a resin including at least one of phenol resin, epoxy resin, and polyimide resin.

A method of manufacturing a semiconductor package 100d described referring to FIG. 5 will be described in detail. A specific description of structures of the semiconductor package 100d already described with reference to FIG. 5 will be omitted. Also, the description of common features already discussed in a process of manufacturing the semiconductor package 100c will be omitted for brevity.

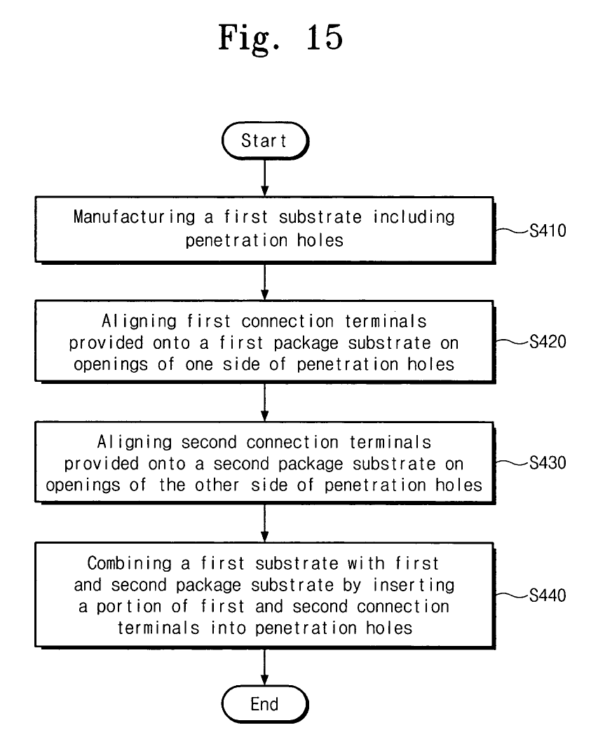

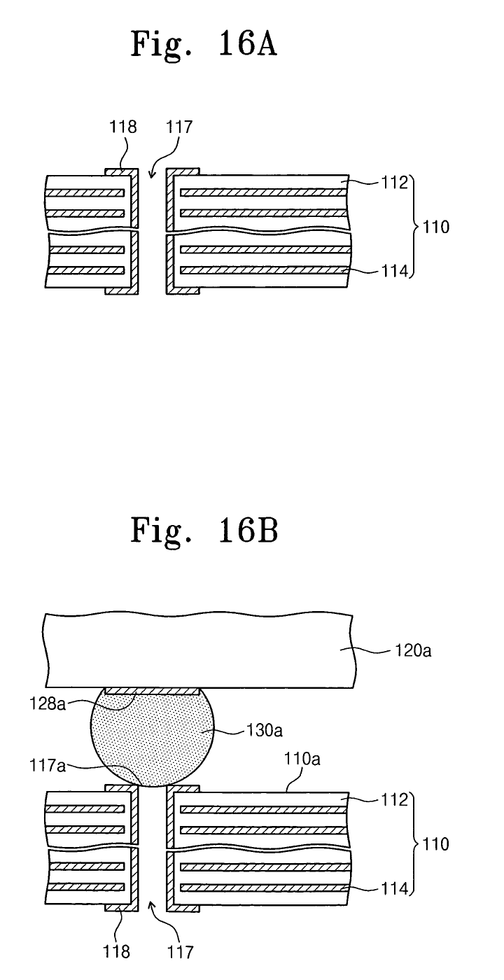

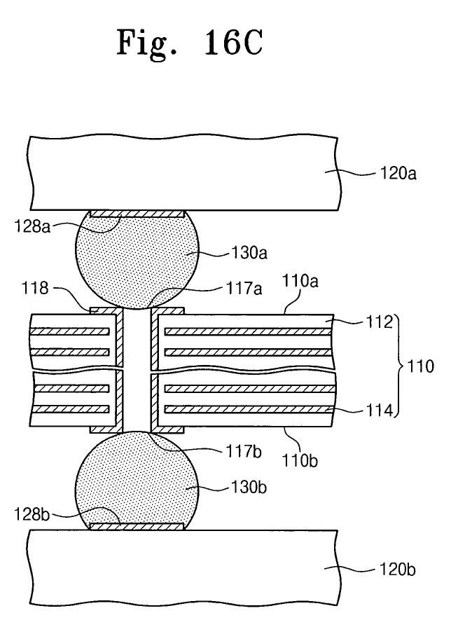

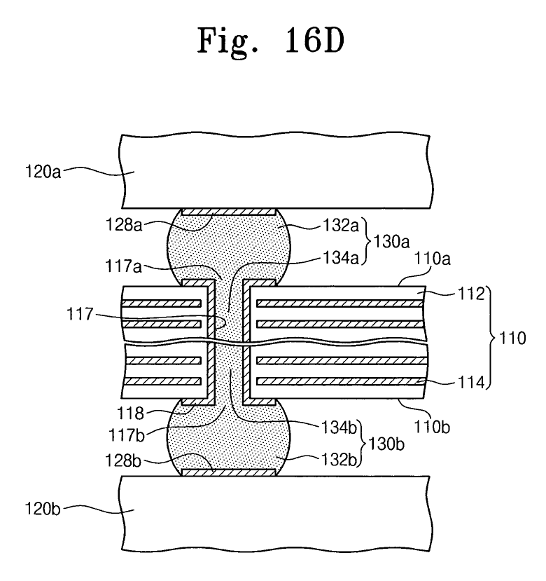

Referring to FIGS. 15 and 16A, a first substrate 110 may be manufactured including penetration holes 117 (S410). The first substrate 110 may be manufactured using the same method of manufacturing the first substrate described in FIG. 14a.

Referring to FIGS. 15 and 16B, first connection terminals 130a on the first package substrate 120a may be aligned with a first opening 117a of the penetration hole 117 (S420). The first package substrate 120a may be a substrate on which a semiconductor chip is mounted. Third pads 128a for welding the first connection terminals 130a may be on the first package substrate 120a. A side of the first package substrate 120a on which the first connection terminals 130a are formed may face the first side 110a of the first substrate, to align the first connection terminals 130a with the first opening 117a of the penetration hole 117.

Referring to FIGS. 15 and 16C, second connection terminals 130b on the second package substrate 120b may be aligned with the second opening 117b of the penetration hole 117 (S430). The second package substrate 120b may be a substrate on which a semiconductor chip mounted on the first package substrate 120a, and/or another semiconductor chip (not shown) are mounted. Fourth pads 128b for welding the second connection terminals 130b may be on the second package substrate 120b. A side of the second package substrate 120b, on which the second connection terminals 130b may be formed, may face the second side 10b of the first substrate, to align the second connection terminals 130b with the second opening 117b of the penetration hole 117. Referring to FIGS. 15 and 16D, the first and second connection terminals 130a and 130b may be inserted into the penetration holes 117 by, e.g., heating the first and second connection terminals 130a and 130b, to couple the first and second package substrates 120a and 120b to the first substrate 110 (S440).

A method of manufacturing a semiconductor package 100e described referring to FIG. 6 will be described in detail. A specific description of structures of the semiconductor package 100e already described with reference to FIG. 6 will be omitted. Also, the description of common features already discussed in a process of manufacturing the semiconductor package 100c will be omitted for brevity.

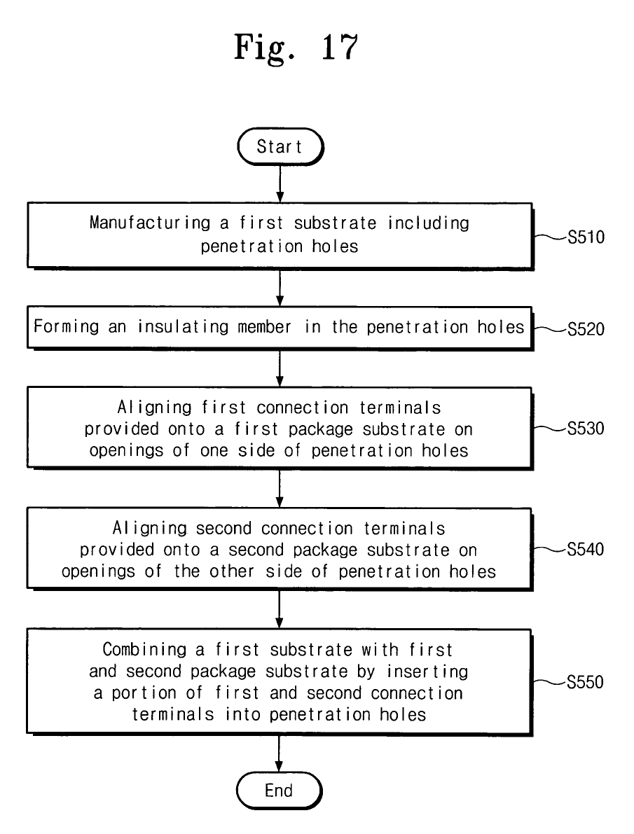

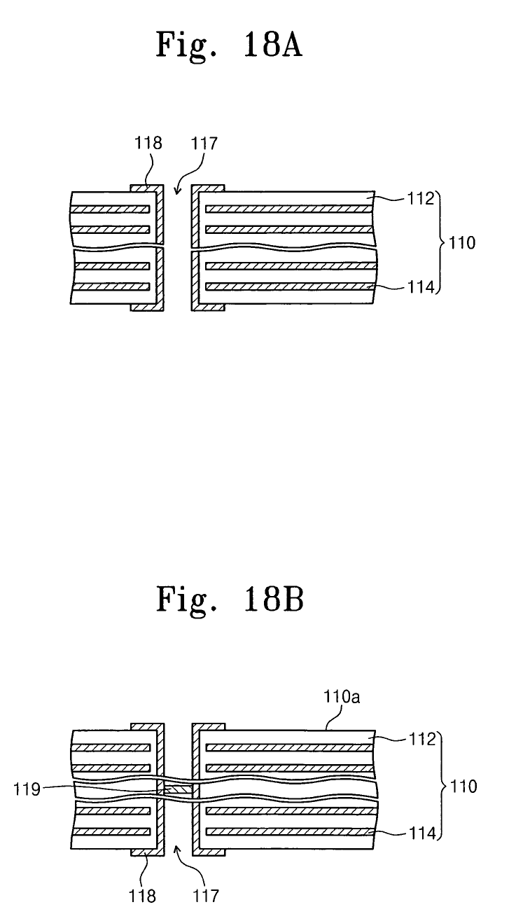

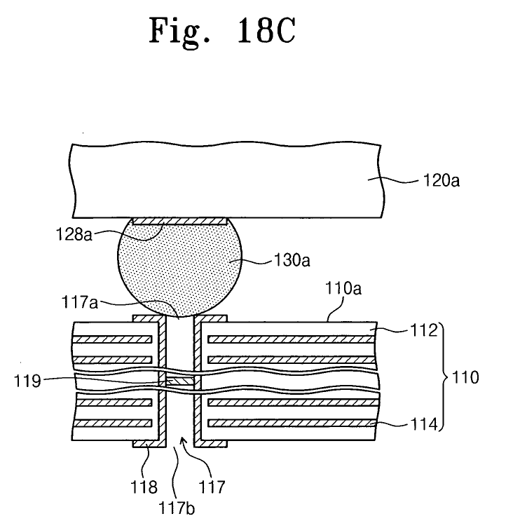

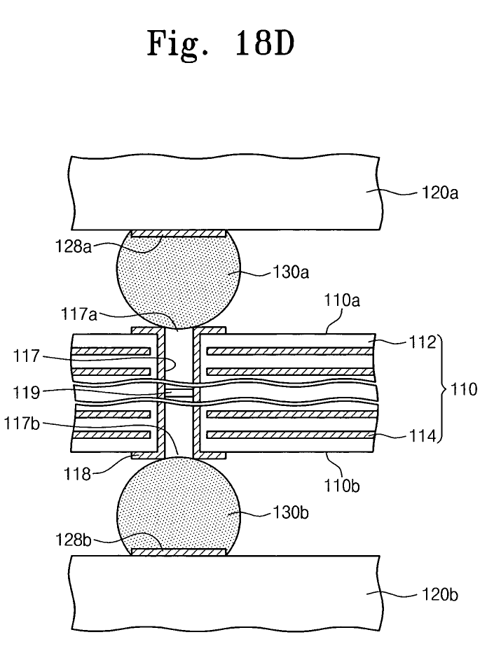

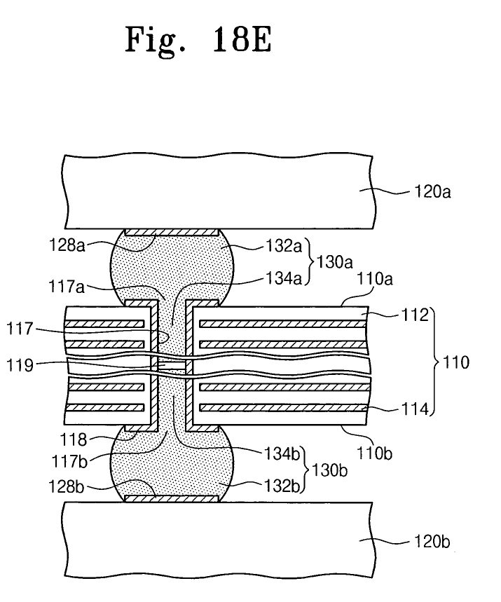

Referring to FIGS. 17 and 18A, a first substrate 110 may be manufactured and may include penetration holes 117 (S510). The first substrate 110 may be manufactured using the same method of manufacturing the first substrate described in FIG. 14a.

Referring to FIGS. 17 and 18B, an insulating member 119 may be formed in the penetration holes 117 (S520). The insulating member 119 may be provided so that respective supporting portions 134a and 134b of first and second connection terminals 130a and 130b, which will be disposed on the first substrate 110, may be electrically isolated from each other. The insulating member 119 may include the same material as an insulating layer 112 of the first substrate 110. The insulating member 119 may include at least one of phenol resin, epoxy resin, and polyimide resin.

Referring to FIGS. 17 and 18C, first connection terminals 130a on a first package substrate 120a may be aligned with a first opening 117a of the penetration holes 117 (S530). The first package substrate 120a may be a substrate on which a semiconductor chip (not shown) is mounted. Third pads 128a for welding the first connection terminals 130a may be on the first package substrate 120a. A side of the first package substrate 120a on which the first connection terminals 130a may be formed may face the first side 110a of the first substrate, to align the first connection terminals 130a with a first opening 117a of the penetration hole 117.

Referring to FIGS. 17 and 18D, second connection terminals 130b on the second package substrate 120b may be aligned with a second opening 117b of the penetration hole 117 (S540). The second package substrate 120b may be a substrate on which a semiconductor chip mounted on the first package substrate 120a, and/or another semiconductor chip (not shown) are mounted. Fourth pads 128b for welding the second connection terminals 130b may be on the second package substrate 120b. A side of the second package substrate 120b, on which the second connection terminals 130b may be formed, may face the second side 110b of the first substrate, to align the second connection terminals 130b with the second opening 117b of the penetration hole 117.

Referring to FIGS. 17 and 18E, the first and second connection terminals 130a and 130b may be inserted into the penetration holes 117 by, e.g., heating the first and second connection terminals 130a and 130b, to couple the first and second package substrates 120a and 120b with the first substrate 110 (S550). Respective supporting portions 134a and 134b of the first and second connection terminals 130a and 130b extending into the penetration holes 117 may be electrically isolated from each other by the insulating member 119.

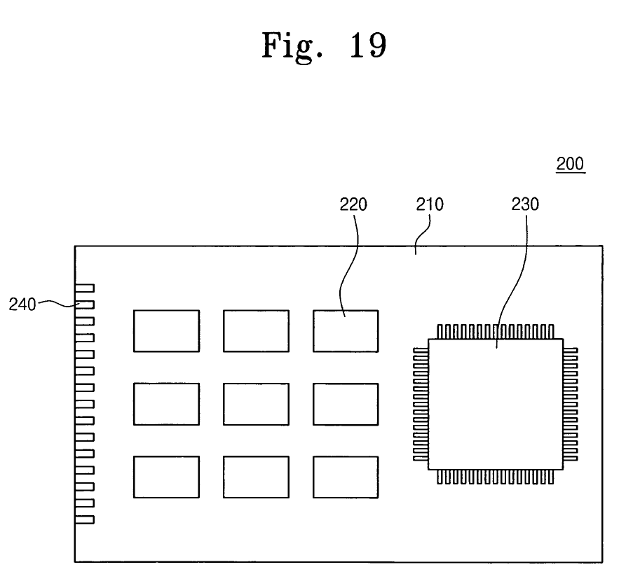

A semiconductor package technique described above may be applied to a variety of kinds of semiconductor devices and a package module including semiconductor devices. Referring to FIG. 19, a package module 200 may be provided as a semiconductor integrated circuit chip and a quad flat package (QFP) 230. The package module 200 may be formed by installing semiconductor devices 220 and 230 to which a semiconductor package technique according to an embodiment may be applied on a substrate 210. The package module 200 may be connected to an external electronic device through an external connection terminal 240 on one side of the substrate 210.

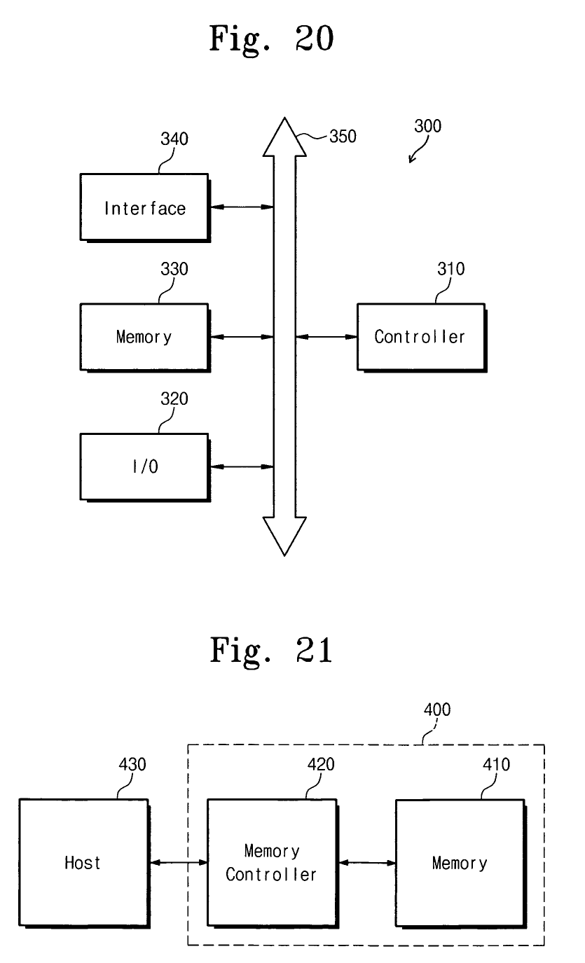

The semiconductor package technique described above may be applied to an electronic system. Referring to FIG. 20, an electronic system 300 may include a controller 310, an input/output device 320, and a memory device 330. The controller 310, the input/output device 320, and the memory device 330 may be connected to each other through a bus 350. The bus may be a path through which data transfers. The controller 310 may include at least one of a microprocessor, a digital signal processor, a microcontroller, and logic devices that can perform a similar function. The controller 310 and the memory device 330 may include a semiconductor package according to an embodiment. The input/output device 320 may include at least one of a key pad, a key board, and a display device. The memory device 330 may be, e.g., a device storing data. The memory device 330 may store data and/or an instruction executed by the controller 310. The memory device 330 may include, e.g., a volatile memory device and/or a nonvolatile memory device. The memory device 330 may include, e.g., flash memory. A flash memory to which a technique of an embodiment is applied may be installed on an information processing system, e.g., a mobile device or a desk top computer. The flash memory may include a semiconductor disc device. In this case, the electronic system 300 may stably store a relatively large amount of data in the flash memory system. The electronic system 300 may further include an interface 340 to transfer data to a communication network or receive data from a communication network. The interface 340 may be, e.g., a cable type or a wireless type. The interface 340 may include, e.g., an antenna or a transceiver. Although not shown, the electronic system 300 may further include, e.g., an application chipset, a camera image processor, and an input/output device.

The electronic system 300 may include, e.g., a mobile system, a personnel computer, an industrial computer, or a logic system performing a variety of functions. The mobile system may include, e.g., a personnel digital assistant (PDA), a portable computer, a web tablet, a mobile phone, a wireless phone, a laptop computer, a memory card, a digital music system, and an information transmission/reception system. When the electronic system 300 is a wireless communication device, the electronic system 300 may be used in a communication interface protocol, e.g., CDMA, GSM, NADC, E-TDMA, WCDMA, and CDMA2000.

A semiconductor device to which a technique of an embodiment is applied may include, e.g., a memory card. Referring to FIG. 21, a memory card 400 may include, e.g., a nonvolatile memory device 410 and a memory controller 420. The nonvolatile memory device 410 and the memory controller 420 may store data or may decode stored data. The nonvolatile memory device 410 may include, e.g., nonvolatile memory devices to which a semiconductor package technique may be applied. The memory controller may control the flash memory device 410 so as to read stored data or write data in response to a request of reading/writing of a host 430.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A semiconductor package, comprising:
a substrate including a socket; and
a connection terminal including a solder ball and a supporting portion extending from the solder ball into the socket.

2. The semiconductor package as claimed in claim 1, wherein the socket includes a groove defined by a sidewall and a bottom surface or a hole penetrating the substrate.

3. The semiconductor package as claimed in claim 1, wherein the substrate includes a multi-layered substrate including a stacked insulating layer and an internal interconnection or a printed circuit board including an internal interconnection.

4. The semiconductor package as claimed in claim 3, wherein at least one connection terminal is electrically isolated from the internal interconnection, and at least one other connection terminal is electrically connected to the internal interconnection.

5. A semiconductor package, comprising:
a substrate including a first socket on a first side of the substrate and a second socket on a second side facing the first side;
a first connection terminal including a first solder ball and a first supporting portion extending from the first solder ball into the first socket; and
a second connection terminal including a second solder ball and a second supporting portion extending from the second solder ball into the second socket.

6. The semiconductor package as claimed in claim 5, wherein the first and second sockets include a groove defined by a sidewall and a bottom surface respectively.

7. The semiconductor package as claimed in claim 5, wherein the first and second sockets are defined by a hole penetrating the substrate, and the first supporting portion is connected to the second supporting portion in the hole.

8. The semiconductor package as claimed in claim 7, further comprising:
an insulating member interposing between the first supporting portion and the second supporting portion in the hole and the insulating member isolating the first connection terminal and the second connection terminal electrically.

9. A semiconductor package, comprising:
a printed circuit board including internal interconnections and sockets;
at least one package substrate facing the printed circuit board; and
connection terminals between the printed circuit board and the package substrate, each of the connection terminals including a supporting portion, the supporting portion being disposed within one of the sockets.

10. The semiconductor package as claimed in claim 9, wherein at least some of the sockets include a groove defined by a sidewall and a bottom surface or a hole penetrating the substrate.

11. The semiconductor package as claimed in claim 10, wherein the connection terminals include support terminals and signal terminals,
the support terminals are electrically isolated from the internal interconnections, and
the signal terminals are electrically connected to the internal interconnections, the printed circuit board, and the package substrate.

12. The semiconductor package as claimed in claim 11, wherein the support terminals are disposed at an edge region of the package substrate.

13. The semiconductor package as claimed in claim 12, wherein the support terminals are disposed at a corner region of the edge region of the package substrate.

14. The semiconductor package as claimed in claim 9, wherein:
the sockets include holes penetrating the substrate,
the package substrate includes:
a first package substrate on which a first semiconductor chip is mounted, the first package substrate coupled to a first side of the printed circuit board, and
a second package substrate on which a second semiconductor chip is mounted, the second package substrate coupled to a second side of the printed circuit board, and
the connection terminals include:
first connection terminals between the printed circuit board and the first package substrate, each of the first connection terminals corresponding to a socket; and
second connection terminals between the printed circuit board and the second package substrate, each of the second connection terminals corresponding to a socket,
wherein a first connection terminal corresponding to a socket is electrically connected to a second connection terminal corresponding to the same socket.

15. The semiconductor package as claimed in claim 9, wherein:
the sockets include holes penetrating the substrate and insulating members in the holes,
the package substrate includes:
a first package substrate on which a first semiconductor chip is mounted, the first package substrate coupled to a first side of the printed circuit board, and
a second package substrate on which a second semiconductor chip is mounted, the second package substrate coupled to a second side of the printed circuit board, and
the connection terminals include:
first connection terminals between the printed circuit board and the first package substrate, each of the first connection terminals corresponding to a socket, and
second connection terminals between the printed circuit board and the second package substrate, each of the second connection terminals corresponding to a socket,
wherein a first connection terminal corresponding to a socket is electrically isolated by the insulating member from a second connection terminal corresponding to the same socket.

16-21. (canceled)
